(19) United States
(12) Patent Application Publication
(10) Pub. No.: US 2022/0027870 A1
(43) Pub. Date: Jan. 27, 2022

(54) TRUSTEE SYSTEM FOR GENERATING STANDARIZED REMITTANCE ADVICE

(71) Applicant: John Crane, Duluth, GA (US)

(72) Inventor: John Crane, Duluth, GA (US)

(21) Appl. No.: 17/499,246

(22) Filed: Oct. 12, 2021

Related U.S. Application Data
(63) Continuation-in-part of application No. 16/247,776, filed on Jan. 15, 2019.
(60) Provisional application No. 62/730,252, filed on Sep. 12, 2018.

(51) Int. Cl. G06Q 20/10; G06F 9/54; G06F 16/953; G06Q 40/02

(52) U.S. Cl. CPC G06Q 20/102; G06Q 40/02; G06F 16/953; G06F 9/541

(57) ABSTRACT

Provided are systems and methods for coordinating batch payment and remittance advice transfer from a trustee to a plurality of creditors in response to a single click. In one example, the method may include receiving disbursement information via a user interface, the disbursement information being associated with a transfer initiated by a trustee, identifying a plurality of attributes from within the received disbursement information including an amount and remittance advice for the transfer, converting the plurality of identified attributes of the transfer into a NACHA file which includes a pre-defined field including the amount, a predefined field including the trustee, and an optional field including a description of the remittance advice, and transmitting the NACHA file to a computing system for processing via an ACH network.

### CROSS-REFERENCE TO RELATED APPLICATIONS

This application claims the benefit under 35 USC § 119(e) of U.S. Provisional Patent Application No. 62/730,252, filed on Sep. 12, 2018, and U.S. patent application Ser. No. 16/247,776, filed on Jan. 15, 2019, the entire disclosures of which are incorporated herein by reference for all purposes.

### BACKGROUND

A bankruptcy trustee serves as a fiduciary to a bankruptcy estate. As part of that fiduciary relationship, the trustee is required to disperse funds from the bankruptcy debtor to the creditors of the debtor. Today, most bankruptcy trustees disperse payments through paper check. In many cases, a creditor will make multiple claims to an estate of a bankruptcy debtor. As an example, a mortgage lender (creditor) may assert multiple claims to a debtor's assets based on timing of the arrearage with the lender. For example, a post-petition debt includes arrearages after the filing of a bankruptcy while pre-petition debt includes arrearages before the filing of the bankruptcy. Other types of mortgage claims include a cram-down, a gap claim, a total debt claim, and the like. When a trustee issues a payment to a creditor (such as a mortgage lender) with multiple claims/accounts, the trustee often provides a single check to aggregate payments for multiple claims. Also, in many cases, the bankruptcy debtor pays his/her bankruptcy attorney through the trustee.

Financial regulations require a creditor to identify which claim a payment is being applied to. Trustees are not required to specify which claim a payment is to be applied. In the case of a mortgage creditor who is owed payment on multiple debts, the mortgage creditor can misidentify and/or inadvertently apply a payment to an incorrect claim because the trustee has failed to adequately identify the payment. In this case, the mortgage creditor subjects itself to violations of state and federal laws. To prevent this from happening, when a creditor receives a paper check which includes payments on multiple claims, the creditor must figure out where to apply the money. Typically, the creditor may access the National Data Center (NDC) database which provides a comprehensive web-based central source for bankruptcy case and claim data. However, this process can be time-consuming and is prone to errors. Furthermore, when a trustee does provide a notification of the debt, there is not a standardized format for describing such a notification. In this case, different trustees typically have their own “terminology” leading to additional errors and delay when identifying payments and claims.

Accordingly, what is needed is a better mechanism for disbursing payments to creditors and debtors' attorneys. Furthermore, creditors and debtor's attorneys need a better mechanism for receiving payments from trustees.

### SUMMARY

According to an aspect of an example embodiment, provided is a computing system that may include a processor to one or more of receive disbursement information via a user interface, the disbursement information being associated with a transfer initiated by a trustee, identify a plurality of attributes from within the received disbursement information including an amount and remittance advice for the transfer, and convert the plurality of identified attributes of the transfer into a file having a National Automated Clearing House Association (NACHA) format which includes a pre-defined field including the amount, a predefined field including the trustee, and a field including a description of the remittance advice, and a network interface configured to transmit the NACHA file to a computing system for processing via an Automated Clearing House (ACH) network.

According to an aspect of another example embodiment, provided is a method that may include one or more of receiving disbursement information via a user interface, the disbursement information being associated with a transfer initiated by a trustee, identifying a plurality of attributes from within the received disbursement information including an amount and remittance advice for the transfer, converting the plurality of identified attributes of the transfer into a file having a NACHA format which includes a pre-defined field including the amount, a predefined field including the trustee, and a field including a description of the remittance advice, and transmitting the NACHA file to a computing system for processing via an ACH network.

Other features and aspects may be apparent from the following detailed description taken in conjunction with the drawings and the claims.

### BRIEF DESCRIPTION OF THE DRAWINGS

FIG. 1 is a diagram illustrating a trustee software environment for initiating transfer of payments and remittance advice to a plurality of creditors in response to single request, in accordance with an example embodiment.

FIG. 2 is a diagram illustrating a user interface for dynamically creating payment transfers in accordance with an example embodiment.

FIG. 3 is a diagram illustrating a process of transforming bankruptcy disbursement information into a NACHA file in accordance with an example embodiment.

FIG. 4 is a diagram illustrating an architecture of a batch transmission including bankruptcy disbursement information in accordance with an example embodiment.

FIG. 5 is a diagram illustrating an example of a NACHA file transmitted from the trustee disbursement platform in accordance with an example embodiment.

FIG. 6 is a diagram illustrating a method of transferring a disbursement in accordance with an example embodiment.

FIG. 7 is a diagram illustrating a computing system that can be used in any of the embodiments described herein.

FIG. 8A is a diagram illustrating a process of pulling and transforming data from a data center, according to example embodiments.

FIG. 8B is a diagram illustrating a process of selecting a standardized remittance advice data for a data record pulled via the API of the data center shown in FIG. 8A, according to example embodiments.

FIG. 8C is a diagram illustrating an example of transforming a claim record into an enhanced and transformed record according to example embodiments.

FIG. 9 is a diagram illustrating a process of submitting a payment and remittance advice to a creditor according to example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown but is to be accorded the widest scope consistent with the principles and features disclosed herein.

The number of claims filed by creditors in a larger bankruptcy case (e.g., Chapter 11, 12, 13, etc.) can be in the hundreds or even thousands. In cases of a Chapter 13 bankruptcy, the proceeding reorganizes the debtor's debt by allowing the debtor to pay creditors some or all of the money that is owed through extended repayment plans. Bankruptcy proceedings often involve a bankruptcy trustee that oversees the administration of a bankruptcy plan for the debtor such as in a Chapter 13 extended repayment plan. A trustee typically receives funds from the debtor (e.g., monthly, etc.) and distributes the funds to creditors under the terms of the bankruptcy plan. As an example, the bankruptcy plan can take three to five years to complete. During this period, the trustee continually receives payments from the debtor and disburses the funds to the creditors until the plan is finished. The trustee must also keep a record (accounting) of all funds received and how much has been disbursed.

Typically, a bankruptcy trustee disburses payments to creditors and others (e.g., debtors attorneys, etc.) in the form of a paper check. For both the trustee and the creditor/receiver, this style of payment causes numerous drawbacks. Creditors often have multiple claims to a debtor's estate. In order to reduce paperwork, trustees using paper check will often aggregate payments across multiple accounts (i.e., being disbursed to the same creditor) within a single check. In other words, the paper check lends itself to aggregation of payments. In this scenario, it can be difficult for a creditor to ascertain which accounts/claims the funds are intended. In all cases, the creditor has to figure out which accounts/claims to apply the funds. To do this, in Chapter 13 cases, often a creditor may visit the NDC website to look up claim information on their case. This can lead to errors and misidentification of payments creating legal issues for the creditor.

Another drawback for creditors can be the difficulty identifying the proper account associated with the payment because the full account number might not be listed (e.g., the account numbers may be hashed, truncated such as last 4 digits, etc.) for security and privacy. As another example, a creditor may transfer or consolidate accounts. In this case, an old account number may be transferred to a new account number or two accounts may be merged into a different account. As a result, an originally provided account number may change leading to more confusion. As another example, a creditor may have issues determining the appropriate manner to apply the payment. Once a creditor marries their record to their loan or their account, there are various buckets which the payment must be applied to. This is often identified by remittance advice or check voucher. However, there is no universal standard of a description which is used for remittance advice or check voucher. Instead, trustees often use their own preference when describing a claim leading to lack of uniformity and further confusion. Paper checks can also be lost and can be easily counterfeited or defrauded.

The example embodiments provide a technical solution to these drawbacks through a trustee disbursement platform that enables a “one-click” push of automated expedited payments from a bankruptcy trustee to creditors (and debtor's attorneys, etc.). The solution ensures that payments are sent to the correct creditor along with remittance advice which provides clear posting instructions for the creditor. The creditor can be identified with a unique ID that is dedicated to the creditor by the platform rather than having to rely on account numbers, etc. which can be lost or truncated. Furthermore, the payment and standardized remittance advice may be converted into a recognizable NACHA format and pushed in batches via an ACH network. In some cases, the payment information and the remittance advice may be uploaded to the platform via an API, or stored in a location where it is accessible to the creditor. Both the trustee and creditor can integrate their systems into this tool. Also, the trustee may use this tool in virtually any type of bankruptcy proceedings including Chapter 7, Chapter 11, Chapter 12, Chapter 13, and the like.

According to various embodiments, the trustee disbursement platform may receive disbursement information that is provided from a trustee which identifies each creditor via a creditor's unique ID. The disbursement information may be provided via fields of a user interface, via a document uploaded from the trustee, and the like. The unique creditor ID may be provided to the creditor when they register with the tool. The disbursement information may include information about the payment being made to the creditor (mapped to the unique ID) such as a payment account, a payment amount, a payment type, tracking information, advanced payment date, and the like. The document may list multiple creditors and payments which are to be processed simultaneously in a batch by the trustee disbursement platform.

In response to the user uploading the document, and making a single request (i.e., pressing a button, option, mouse click, etc.) on the user interface, the trustee tool may detect the request (e.g., the button press, the option press, the mouse click, etc.) and identify a plurality of payments to be processed from the document. In response to the detection, the trustee platform may trigger a payment network to pull the funds from a trustee account and push the funds to a plurality of creditors via an ACH network or other similar electronic payment mechanism. In addition, the trustee platform may simultaneously push remittance advice to the creditors.

In some embodiments, the pushing and the pulling of payments and remittance advice may be triggered via an ACH network. Here, the payments and remittance advice may be pushed using ISO 20022 messages, or the like. In some embodiments, the ACH messages may include one or more of a file header record, a batch header, entry detail record, addenda, batch trailer record, file trailer record, or the like. Furthermore, the ACH messages may have positional syntax, have a consistent length for each record (e.g., 94 bytes, etc.), start with a two-byte fixed string, consist of six record types, and the like. Furthermore, ISO 20022 messages may be used to push the remittance information to creditor systems. According to various embodiments, bankruptcy-specific information associated with the trustee and/or the creditor may be extracted from the input/file received from the trustee and converted into a NACHA file format. The NACHA file is recognized by the ACH network.

One of the solutions provided by the example embodiments is enabling the trustee software tool to “talk” to the ACH network/infrastructure thereby allowing the trustee software tool to push payments and remittance advice to creditors. In some embodiments, an interface may be created between the trustee software tool and the ACH network based on an application programming interface, a software connector library, or the like.

In operation, the trustee software is capable of simultaneously pushing/disbursing funds across multiple creditor accounts and remittance advice to creditor systems through a single click (i.e., one-click) and without the need for a paper check. The trustee software prevents misapplication of funds by a creditor because each payment is identified through the unique ID. Furthermore, a trustee is not required to generate multiple payments (e.g., checks) to satisfy multiple accounts to a same creditor. Instead, a single click can be used to transfer multiple payments to a creditor which are independently identified with different unique IDs which are dedicated to each respective account/claim.

Another benefit of the example embodiments is the accessibility and security that is created by the trustee platform. To perform an ACH transfer, a trusted relationship must be established between the payor (trustee) and the payee (creditor). This typically involves two parties agreeing to conduct financial transactions along with the exchange of sensitive financial information (banking account numbers, etc.). Furthermore, there is no streamlined manner for trustees to establish ACH relationships with creditors. Instead, these relationships must be created on an individual basis.

A bankruptcy proceeding may involve many creditors (100 s, 1000 s, etc.). To setup an individual ACH relationship with hundreds or thousands of creditors would require significant time and exposure of sensitive financial data. The example embodiments, however, remove the barriers in creating ACH relationships between trustees and creditors because trustees and creditors register with the trustee platform. The platform ensures that the banking information is valid, the person providing such information is authorized to act on behalf of the creditor, etc., and further assigns each registered creditor with their own unique ID. As a result, by simply joining the trustee platform, a trustee is integrated into an ACH relationship with many potential creditors, and vice versa. Furthermore, a trustee does not have to vet potential banks/creditors because the platform has already gone through the verification process to ensure that an individual at a bank/creditor is authorized to conduct financial transactions on behalf of the bank/creditor.

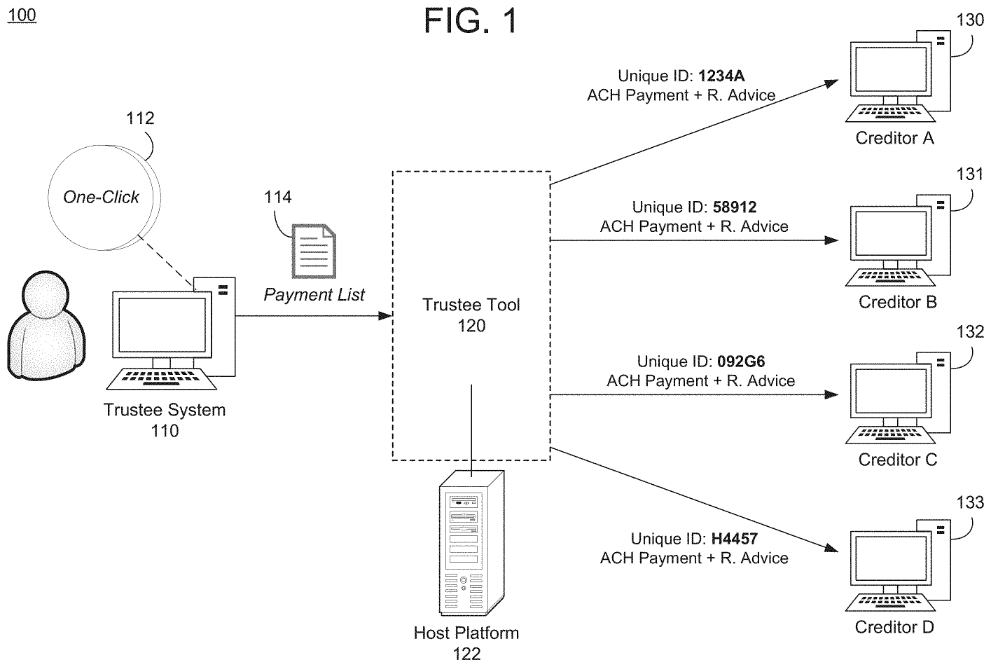

FIG. 1 illustrates a trustee software environment 100 for pushing payments and remittance advice to a plurality of creditors in response to single request, in accordance with an example embodiment. Referring to the example of FIG. 1, the environment 100 includes a trustee system 110, a trustee software tool 120 hosted by a host platform 122 (also referred to herein as a trustee disbursement platform), and a plurality of creditor system 130-133. The trustee software tool 120 may be a web-based platform which a trustee may access via a network (e.g., the Internet) to disburse ACH payments to creditors 130-133 via a payment network and further transmit remittance advice via ACH, a non-payment network such as the Internet, an application programming interface (API), or the like. In some cases, the trustee software tool 120 may contain an ACH pipeline to facilitate expedited payment from a trustee payment account to creditor payment accounts while also pushing remittance advice to the creditor as well.

In the example embodiments, the trustee software tool 120 may be executed by a processor (e.g., a hardware processing device) that is within the host platform 122. Furthermore, the steps that are carried out by the trustee software tool 120, including displaying a user interface, detecting selections on the user interface, querying an API of a web server (e.g., the National Data Center, etc.), standardizing claim records received from the web server, generating standardized remittance advice, adding the standardized remittance advice to a data record queried from the API, generating NACHA files, transmitting the NACHA files on an ACH network, and the like, may be performed by the processor of the host platform 122.

As described herein, standardized remittance advice may be used to identify one or more attributes of a bankruptcy claim. For example, the remittance advice may include a pre-defined payment type from among a plurality of possible pre-defined payment types. These pre-defined payment types may include standardized payment types including, but not limited to, auto, credit card, unsecured, student loan, property taxes, other taxes, debtors attorney's fees, utilities, child support, mortgage pre-petition, mortgage post-petition fee, mortgage—total debt claim, mortgage—cramdown, mortgage—gap claim, mortgage—other, other, and the like. These pre-defined remittance advices can be standardized and used through the platform by all trustees.

The remittance advice may be in a standardized format that prevents different descriptions from being used. Rather, a trustee/user may be provided with a standard list of “descriptions” or it may be automatically generated for the trustee by default. The remittance advice may also be included with one or more additional attributes of the bankruptcy such as an identification of the bankruptcy case (e.g., by number), a unique ID associated with the claim and assigned by the trustee disbursement platform, a jurisdiction, an account number (last 4 digits, etc.), a debtor name, and the like. The host platform 122 may receive the bankruptcy remittance information and transform the remittance information into a format that can be transmitted along the rails of an ACH network. In some embodiments, the platform may extract the remittance information and insert it into an optional addenda field of a NACHA file.

In the example of FIG. 1, the creditors A, B, C, and D may register with the trustee software tool 120 via creditor systems 130, 131, 132, and 133, and receive a unique ID in response. During registration, the creditors may provide payment account information, claim information, etc., to the trustee software tool 120. Likewise, a trustee may register with the trustee software tool 120 via a trustee system 110 and become part of the trustee registry capable of sending payments through the software tool 120.

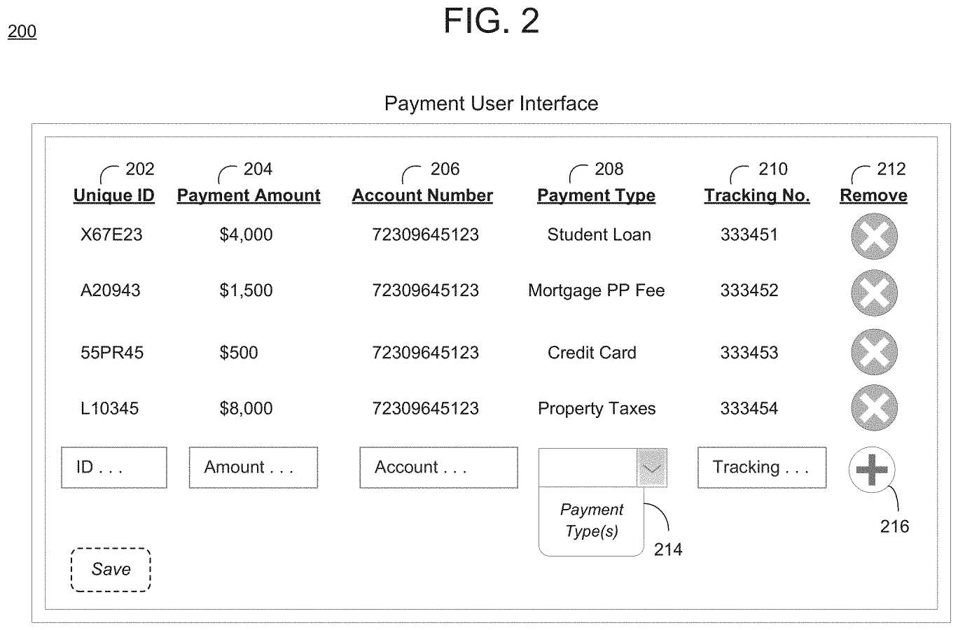

The trustee may send a batch of payments to a plurality of creditors A, B, C, and D, associated with creditor systems 130, 131, 132, and 133, respectively. In order to send the payments, the trustee may upload a document 114 through the trustee system 110 which includes information about the creditors and the claims, as well as remittance information. As another example (shown in FIG. 2), the trustee may input disbursement information via fields of a user interface for transferring payments.

When the trustee submits a single request via the trustee system 110, for example, selects a button 112 on a user interface of the trustee software tool 120, the trustee software tool 120, via the host platform 122, may initiate a pulling of funds from the trustee account and pushing the funds to each of the respective creditors A, B, C, and D. Here, the trustee software tool 120 may identify payment account information of the creditors A, B, C, and D, included in the document 114, amounts to pay, tracking, payment type, advanced payment information, and the like, and trigger disbursement of the funds from the trustee's payment account to the creditor accounts via an ACH network. Likewise, the trustee software tool 120 may generate remittance advice which includes the standardized description of the payment type plus additional bankruptcy attributes based on the data included in the document 114 (e.g., account number, payment type, etc.) and submit the remittance advice to a storage that is accessible to the creditor systems 130-133. The initiation of the pulling and pushing may include a request from the host platform 122 to a financial institution of the trustee to send the funds on behalf of the trustee. Here, the trustee may give authorization to the host platform 122 to act on their behalf and communicate with their financial institution. As a result, a trustee simply registers with the host platform 122, and they are given the ability to efficiently and effectively transmit funds to many creditors.

In this example, the trustee software tool 120 enables a one-click transfer of both payment (via an ACH transaction) to the plurality of creditors plus remittance advice (non-financial) and other bankruptcy information from the trustee to a plurality of creditor systems telling the creditor how to apply the payment. Furthermore, the remittance advice may be in a uniform standard that the trustee is required to use via the software tool 120 thereby removing confusion that can be caused without standardized remittance advice. For example, the remittance advice may be pushed to a system such as a cloud platform, server, database, or the like, where the creditor systems 130-133 can pull the remittance advice or where it can be fed automatically the creditor systems 130-133 via an API between the trustee software tool 120 and the creditor systems 130-133. Accordingly, there's a financial push and a non-financial push of information to creditors.

According to various embodiments, a creditor may register with the trustee tool. The registration puts the creditor on the system and allows them to receive payments from any trustee on the system. The creditor may perform registration on an account level. In this way, each claim/account that the creditor has can be independently identified via the trustee tool. For example, for every account in default, the creditor may file a proof of claim. Here, the creditor may add to their unique ID for the trustee tool to the proof of claim thereby marrying the payments from the trustee to the creditor's actual account (debt) and not just a general payment. Likewise, trustees can register with the system and provide information of their financial institution and authorization to the trustee tool 120 to trigger payment disbursement on behalf of the trustee with the trustee's financial institution.

A bankruptcy trustee may remit payments in batches. For example, the trustee may have to provide 50 checks to a creditor to make a payment on 50 debts. This can be complicated and burdensome because it is often unclear which checks correspond to which accounts of the creditor. In other words, it can be confusing on how to apply the payments. In contrast, the trustee tool works on a transaction level. With the trustee tool described herein, a batch payment can be made that disperses the example 50 payments through a single click. The tool then pulls the money from the trustee account and pushes the payment through the trustee tool through ACH to the creditor using their unique ID. Furthermore, the remittance advice is also pushed to a creditor system or a location where it can be acquired or fed to the creditor system. In addition, the trustee tool may maintain a user interface or ledger that tracks payment information made to all creditors. Here, the user interface can identify how much money has been paid, dates, remaining payments, and the like.

To perform the one-click push processes, the trustee may upload a list in the form of a spreadsheet, word processor document, .csv file, and the like. As another example, FIG. 2 illustrates a user interface 200 for dynamically creating a document or file which can be uploaded by a trustee to effect payment transfers in accordance with an example embodiment. For example, the trustee may upload a list (.csv, spreadsheet) that contains unique creditor identifier numbers, account numbers (creditor) and an amount of the payment. It may also contain remittance advice in the format that tells the creditor how to post the payment (standardized format). The system forces the trustee to use one reporting standard so to speak, so creditors can build their own API into the tool.

In the example of FIG. 2, the user interface enables a trustee to build a file such as document 114. In this example, the user interface enables the trustee to input information into fields for a unique creditor ID 202, a payment amount 204, a payment account number 206 of the creditor, a payment type 208, a tracking number, and the like. In some embodiments, the payment type 208 may be standardized through the use of a drop-down box or other tool that limits the options of a trustee when identifying the payment type thus limiting the types of remittance advice that can be provided. Although not shown in FIG. 2, other fields may be present such as advanced payment, and the like. In addition, the user interface 200 provides the user with a remove option 212 to remove payments, and an add button 216 to add new payments.

The trustee tool may read the document which can be dynamically filled-in via the user interface 200 and generate instructions to disperse payments to the creditors based on the information identified within the document. Also, the trustee tool may simultaneously generate remittance advice including the bankruptcy attributes based on the information within the document (e.g., unique ID 202, payment amount 204, account number 206, payment type 208, etc.) for the respective payment. Accordingly, a trustee can access a system to disperse its payments across all its creditors with one click of a button. Once click can make hundreds and even thousands of payments.

In some embodiments, the trustee software tool may receive a document that includes trustee disbursement information for transferring payment to multiple different creditors. As an example, the document may include similar fields as shown in the user interface 200 of FIG. 2 where different creditors are identified by their unique IDs, and corresponding payment information is set for each creditor including amount, account, payment type, tracking, and the like.

In response to receiving or otherwise detecting a single request such as a mouse click, enter command, button press, etc., via a user interface or other input device (voice, gesture, etc.), the software tool, via the platform, may trigger a batch push process which pushes payments and remittance information along the rails of an ACH network. The trustee software tool may request/trigger a financial institution such as the trustee's bank to transfer funds from the trustee's account to accounts/banks of the respective creditors. In order to facilitate this process, the trustee software tool may convert the trustee/user provided disbursement information into a format that is recognizable by an ACH network. This format is referred to as NACHA, or a NACHA file. Disbursement information can be extracted from the trustee's input/upload and inserted into various fields of a NACHA file. Remittance advice identifying the bankruptcy case, the claim, the debtor, the payment type, etc., may be stored in an optional field of the NACHA file known as the addenda field.

To facilitate transfer, the software tool may transmit the NACHA file (or a plurality of NACHA files) for each transaction to the trustee's financial institution to trigger payment to a plurality of creditors. Here, the payments may be transferred using ISO 20022 messages, or the like. In some embodiments, the ISO 20022 messages may include the fields for the NACHA file provided by the trustee software tool such as one or more of a file header record, a batch header, entry detail record, addenda, batch trailer record, file trailer record, or the like. Furthermore, the ACH messages may have positional syntax, have a consistent length for each record (e.g., 94 bytes, etc.), start with a two-byte fixed string, consist of six record types, and the like. Furthermore, ISO 20022 messages may be used to push the remittance information to creditor systems.

In some embodiments, a plurality of unique identifiers included in disbursement information such as an uploaded document, may be internally mapped to a plurality of creditor accounts such that each creditor account is associated with its own unique identifier. In some embodiments, each unique identifier included in the document may be associated with a plurality of data fields that can be filled-in to provide additional information about a creditor associated with the unique identifier. Here, the fields of data may be identified by columns in a table, and payment information from a creditor information may be included in a row of the table. In some embodiments, the plurality of data fields may include one or more of a payment account number field, a payment amount field, a tracking number field, and payment type field to be used for remittance advice. In some embodiments, the payment type field comprises a drop-down box with standardized payment remittance options capable of being selected.

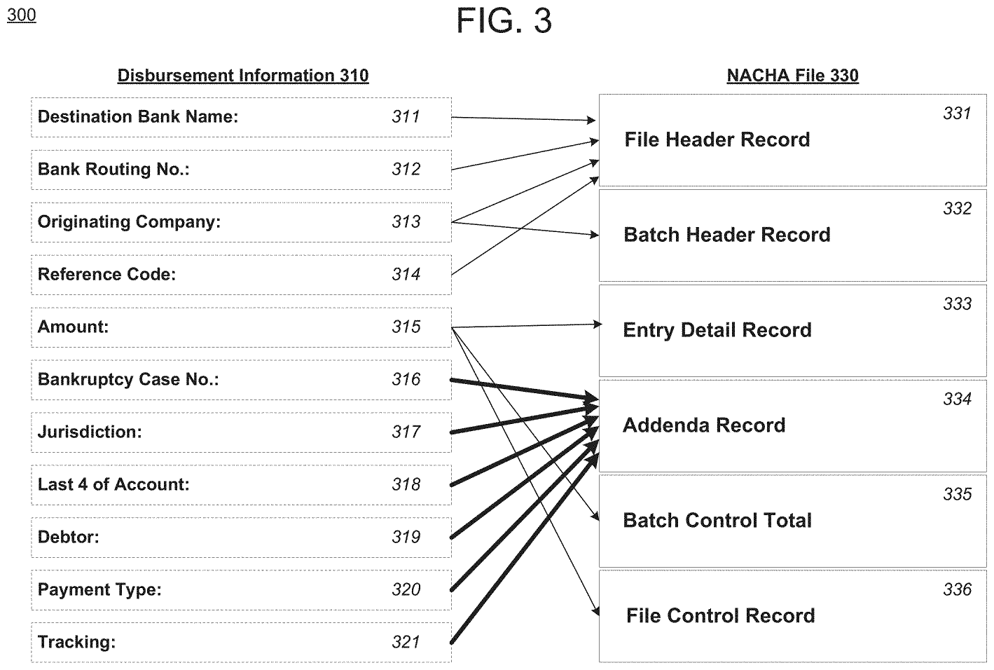

FIG. 3 illustrates a process 300 of transforming bankruptcy disbursement information into a NACHA format in accordance with an example embodiment. Referring to FIG. 3, in process 300 disbursement information 310 is converted into a file 330 having a NACHA format which is referred to herein as a NACHA file. In this example, the disbursement information 310 may be provided via a document or file (e.g., word processor document, spreadsheet, data file, etc.) which is uploaded via a web-based user interface. As another example, the disbursement information 310 may be filled-in by a user through inputs via fields of the web-based user interface. In this example, the disbursement information 310 is associated with one transfer. However, it should be appreciated that a batch (many) transfers may be processed at the same time. In this case, the disbursement information 310 may include information associated with the batch of transfers.

According to various embodiments, the disbursement information 310 may include attributes of the bankruptcy proceeding that may be provided by the trustee. As a non-limiting example, the disbursement information 310 may include a destination bank name 311 of the creditor, a bank routing number 312 of the creditor, an originating company 313, a reference code 314, a payment amount 315, a bankruptcy ID such as a case number 316, a jurisdiction 317 of the bankruptcy proceeding, an account number 318 of the creditor or a claim ID, a debtor name 319 of the bankruptcy proceeding, a payment type 320, a tracking number 321, and the like.

Here, attributes of the disbursement information 310 may be transformed from the input format into a format capable of being transmitted through the rails of an ACH network. The format for generating an ACH transfer file is referred to as the NACHA file 330. For example, the destination bank name 311, the routing number 312, the originating company 313, and the reference code 314 may be extracted and inserted into a file header record 331 of the NACHA file 330. Furthermore, the originating company name 313 may be inserted into a batch header record 332. Meanwhile, the amount 315 can also be inserted into an entry detail record 333, a batch control total 334, and a file control record 336.

According to various embodiments, remittance advice may be extracted from the disbursement information 310 and inserted into an optional record 334 of the NACHA file 330. Here, the remittance advice may include a standardized payment type description. In addition, other attributes of the bankruptcy may be extracted and incorporated with the payment type as part of the remittance advice including information that identifies the creditor's claim, account associated with the debt, invoice number, etc., associated with the payment. In the example of FIG. 3, the system may extract the bankruptcy case number 316, the jurisdiction 317, the account number 318, the debtor name 319, the payment type 320 (standardized remittance advice), and the tracking number 321 from the disbursement information 310 and insert into the optional addenda record 334 of the NACHA file 330 which makes up remittance information.

According to various aspects, trustees register into the system and go through a strict verification process. After successful verification, the trustee may receive an access key that enables them to get to the registration screen. Then a verification team will update their access to active. The same thing applies for any creditor that wants to log into the system. They register, verify, and once verified their account is marked as active.

Once the trustees and creditors are active in the system, the trustee has several ways to send payment to the creditors. They can click on a single payment transfer option, or a batch payment transfer option. The trustee enters in (current date, amount, creditor name, unique creditor ID, tracking number, bankruptcy case ID, jurisdiction, etc.) They then submit the payment with a SUBMIT button. As another option, the trustee may upload a data file with all of this information already entered therein. In response, the host platform may create an ACH file in NACHA format and forward the NACHA file to the trustee's bank. During the registration, the platform may be provided permission to act on behalf of trustee to send that NACHA file to the trustee's bank via a secure File Transfer Protocol (FTP) server, a secure web portal, or the like. Once sent, the bank sends back an ACH File as a response, and further processes the payment transfer from the trustee's account to the bank account of the creditor or batch of creditors.

The input data from the trustee may be taken from a front-end user interface (website) and converted into NACHA format based on the application. Code within the application (e.g., C#, etc.) encodes the user-provided data to the NACHA format. In this case, the code may receive the input and produce the NACHA file as the output thereby converting the input data into a format that can be transmitted via an ACH network. The customization of the input data may include an agenda line which includes customized information for identifying the bankruptcy claim so that when the creditor receives the payment they also receive the agenda line (remittance advice) giving them the information needed to identify the claim associated with the payment, and without requiring the creditor to look for information elsewhere such as NDC database, etc. As an alternative embodiment, the trustee may interact with the trustee tool software through an API where the user can interact and upload data.

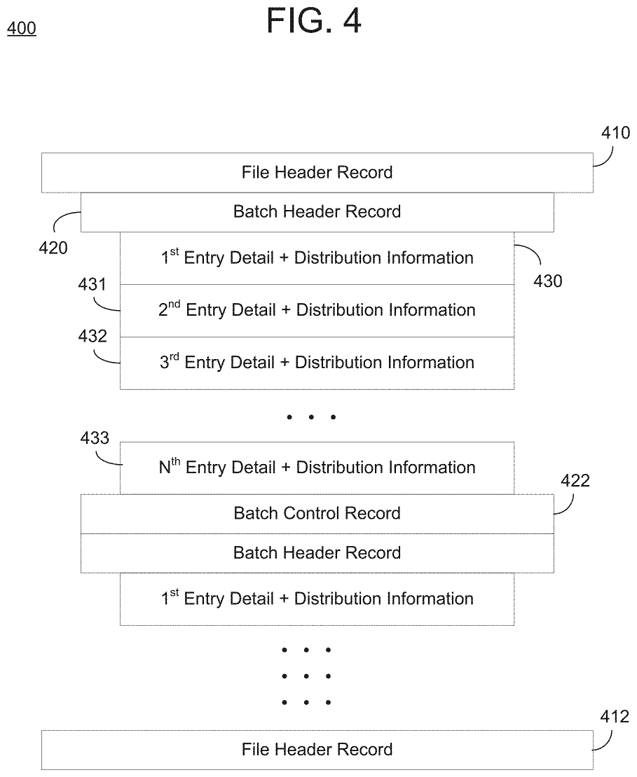

FIG. 4 illustrates an architecture 400 of a batch transmission of NACHA files in accordance with an example embodiment. For example, the architecture may include the layers of a NACHA file or a batch of NACHA files associated with payment from a trustee to one or more creditors which may be processed via an ACH network. In this example, the architecture includes a file header record 410, a batch header record 420, a plurality of entry detail records 430-433 and a batch control record 422. Additional batches of transactions may be included in the transmission which include a batch header, a batch control, and one or more entry detail records therein. Furthermore, the end of the transmission may include a file header 412, also referred to as a file trailer header.

The file header record 410 may include a name of the trustee's company and company number, a destination bank, and the like. The batch header record 420 may include an effective entry date for settling the payment, an identification of the company, an entry description of the credits/debits in the batch, and the like. Each entry detail record (e.g., 430-433) may include information necessary to post a deposit/withdrawal to/from an account such as the creditor's name, account number, dollar amount of the payment, and the like. Furthermore, additional information of the disbursement such as remittance advice may be added in an addenda record which may be added as an addendum to the entry detail record. Although conceptually shown as being incorporated together with the entry detail records 430-433, the remittance advice including the payment type and additional bankruptcy attributes may be included as a separate line in the transmitted NACHA file. The addenda record may include bankruptcy number, account number, claim information, invoice information, debtor name, type of payment (standardized description), tracking information, etc. The batch control record 422 appears at the end of each batch and contains totals of the batch, and the file control record 412 provides a final check on the data submitted. It contains block and batch counts and totals of each entry.

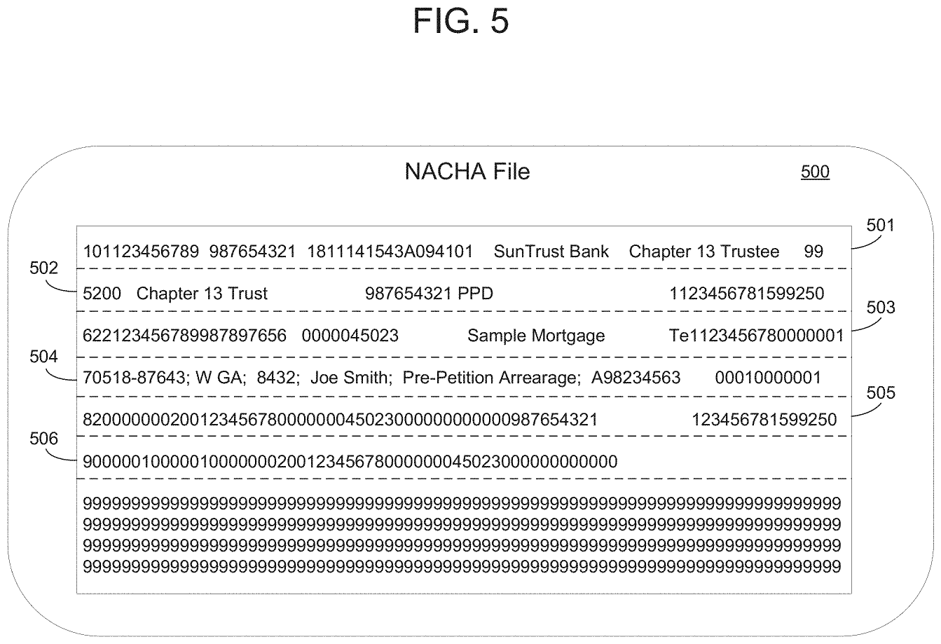

FIG. 5 illustrates an example of a NACHA file 500 (ACH file) generated by the trustee disbursement platform in accordance with an example embodiment. The file 500 is configured for transmission across an ACH payment network. In this example, an input file is received and includes the following data values shown Table 1:

TABLE 1

| | |
|---|---|
| Destination Bank Name | Sun Trust Bank |
| Dest. Routing Number | 123456789 |
| Orig. Company Name | Chapter 13 Trustee |
| Reference Code | 99 |
| Amount | $450.23 |
| Bankruptcy Case No. | 18-87643 |
| Jurisdiction | North Georgia |
| Last 4 of Account | 8432 |
| Debtor | Joe Smith |
| Payment Type | Pre-Petition Arrearage |
| Tracking No. | A98234563 |

Here, the platform may generate the file 500 in the NACHA format for transmission across the ACH network. In particular, a file header record 501 includes the destination bank name, the routing number, the originating company name, and the reference code, a batch header record 502 includes the company name, an entry detail record 503 includes an account number, routing number, a telephone number, name of the debt, and a payment amount, an entry detail addenda record 504 includes the bankruptcy case number, jurisdiction, last 4 of the account number, debtor name, standardized payment type, and a tracking number, a batch control total 505 includes batch information and the payment amount, and a file control record 506 includes file information and the payment amount. It should be appreciated that the file 500 shown in FIG. 5 is just for purposes of example and is not meant to limit the example embodiments.

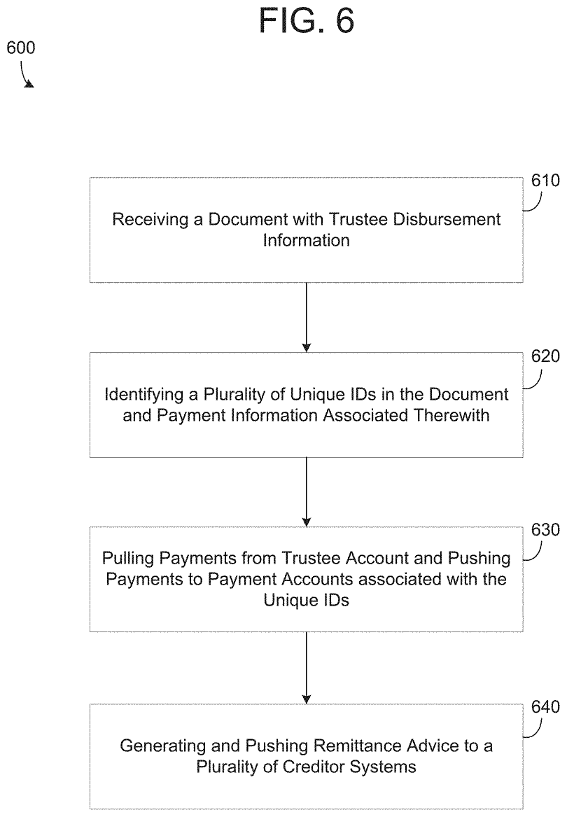

FIG. 6 illustrates a method 600 of transferring a disbursement from a trustee to creditors in accordance with an example embodiment. For example, the method 600 may be performed by the trustee tool described herein that is executed by a host platform such as a web server, a cloud environment, an on-premises server, a user device, and the like. Referring to FIG. 6, in 610, the method may include receiving disbursement information via a user interface. Here, the disbursement information may be associated with a transfer initiated by a trustee of a bankruptcy proceeding. The disbursement information may include a file or document that is uploaded via the user interface. As another example, the disbursement information may include user inputs that are entered into fields of the user interface and then saved to create a document. The disbursement information may include information needed to transfer a payment from a trustee account to a creditor account. In addition, the disbursement information may include remittance advice which specifically identifies the bankruptcy claim. The disbursement information may also include a unique ID associated with the creditor who is to receive the transfer of payment.

In 620, the method may include identifying a plurality of attributes from within the received disbursement information including an amount and remittance advice for the transfer. The attributes may include a destination bank name, a trustee name, a trustee company name, trustee payment account number, bankruptcy case number, tracking number, an amount, a creditor bank name, a creditor account number, payment type, debtor name, and the like. Examples of the disbursement information are shown in FIG. 3, however, embodiment are not limited thereto.

In 630, the method may include converting the plurality of identified attributes of the transfer into a file having a NACHA file format which includes pre-defined fields for all of the identified disbursement information such as the amount, trustee information, debtor information, account information, and the like. In addition, the NACHA file may include an optional addenda field which includes a description of the remittance advice. For example, the remittance advice may include one or more of bankruptcy case information, payment type information, jurisdiction information, creditor account information, creditor claim information, tracking information, and the like. In 640, the method may further include transmitting the NACHA file to a computing system such as a trustee financial institution for processing via an ACH network.

In some embodiments, the converting may include extracting the description of the remittance advice from the disbursement information and inserting the description of the remittance advice in an optional field of the NACHA file. In some embodiments, the description of the remittance advice may be a standardized description selected from among a plurality of standardized descriptions for a plurality of different types of payments, respectively. Here, the standardized description may be uniformly applied/used by a plurality of registered trustees that have registered with the platform.

In some embodiments, the converting may include converting the batch of transfers into a plurality of NACHA files, and the transmitting may include transmitting the plurality of NACHA files to a plurality of computing systems associated with the batch of transfers. In some embodiments, the converting of the batch of transfers into a plurality of NACHA files is performed in response to a single-click selection being detected via the user interface.

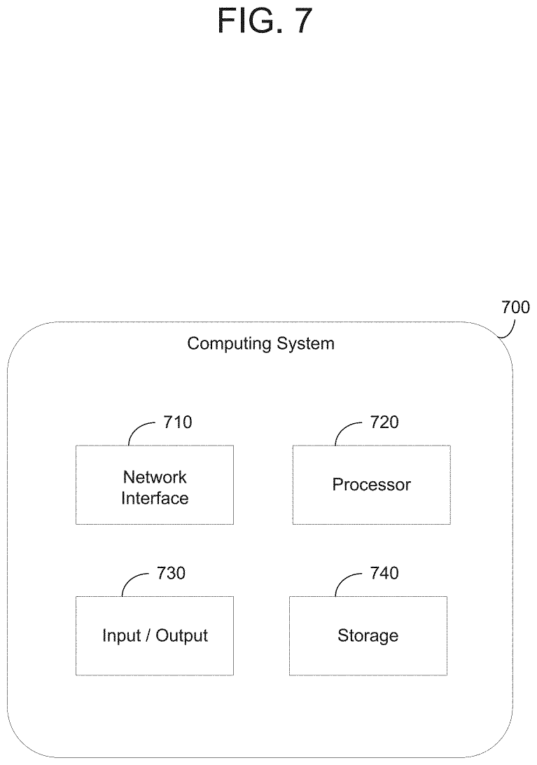

FIG. 7 illustrates a computing system 700 that can be used in any of the example embodiments described herein. For example, the computing system 700 may be a web server, a database, a cloud platform, a user device, a server, or the like. In some embodiments, the computing system 700 may be distributed across multiple devices. Referring to FIG. 7, the computing system 700 includes a network interface 710, a processor 720, an input/output 730, and a storage device 740 such as a memory device. Although not shown in FIG. 7, the computing system 700 may also include or be electronically connected to other components such as a display which may include an embedded display panel, an externally connected monitor, a network connection device having a display, etc., an input unit, a receiver, a transmitter, and the like. The processor 720 may control or replace any of the components shown in the computing system 700. Also, it should be appreciated that the processor 720 may perform each of the steps of the method 600 and the method 900 which are described herein.

The network interface 710 may transmit and receive data over a network such as the Internet, a private network, a public network, an enterprise network, and the like. The network interface 710 may be a wireless interface, a wired interface, or a combination thereof. The processor 720 may include one or more processing devices each including one or more processing cores. In some examples, the processor 720 is a multicore processor or a plurality of multicore processors. Also, the processor 720 may be fixed or it may be reconfigurable. The input/output 730 may be a port, a cable, a connector, etc., that can be used to input and output data to and from the computing system 700. The storage device 740 is not limited to a particular storage device and may include any known memory device such as RAM, ROM, hard disk, and the like. The storage 740 may store software modules or other instructions which can be executed by the processor 720 to perform the method 600 shown in FIG. 6.

According to various embodiments, the processor 720 may output or otherwise display a user interface associated with the trustee tool described herein. Through the user interface, the processor 720 may detect and/or receive disbursement information. The disbursement information can be provided by a trustee who is initiating payment transfer from the trustee's account to one or more creditor accounts of a bankruptcy proceeding. The disbursement information may be a file that is uploaded with a batch of transfers. As another example, the disbursement information may be inputs that are collected via a user interface. The processor 720 may identify a plurality of attributes from within the received disbursement information including an amount and remittance advice for a transfer. In this case, the processor 720 may convert the plurality of identified attributes of the transfer into a NACHA file format which includes a pre-defined field including the amount, a predefined field including the trustee, and a field including a description of the remittance advice. An example of the NACHA file is shown in FIG. 5. Furthermore, the processor 720 may control the network interface 710 to transmit the NACHA file to a computing system for processing via an ACH network.

Although the example embodiments describe the trustee disbursement tool being used for bankruptcy proceedings, it should be appreciated that the system described herein may be used for different types of payment processes. As another example, a probate administrator could use the system when administering a probate estate. The software process may provide the same one-click mechanism for transferring payment to a plurality of receivers of the estate without the need to establish an independent ACH relationship between the administrator and the receiving entities. Furthermore, probate still has remittance advice, just not quite as robust.

According to various embodiments, the trustee software tool described herein may also be used to pull bankruptcy data from a national database, for example, the National Data Center which can be accessed at https://www.ndc.org/. For example, the trustee software tool may query an application programming interface (API) of the NDC for records using a unique identifier such as a claim ID, a bankruptcy proceeding ID, a trustee ID, and the like. Here, the API may be a Web-based API that can be queried using hypertext transfer protocol (HTTP) queries. The queries may include the unique identifier embedded within a field thereof. Furthermore, the trustee software tool may perform this same process on a regular basis (e.g., hourly, daily, weekly, etc.) for many (e.g., thousands) of other different claims, proceedings, etc. In this case, the trustee software tool may perform thousands of HTTP queries in just a short amount of time (e.g., one minute or less, etc.) Here, the data may also be returned via an HTTP response message from the web API, or the like.

Furthermore, the data that is pulled from the NDC is unstructured. In this case, the data returned may be one long string value with many different values (e.g., 30 or more data values) of the bankruptcy claim/proceeding data included therein. The trustee software tool is configured to transform (e.g., normalize) the data that is returned from the NDC into a structured format that includes predefined fields and predefined values and store the structured format in a file such as a NACHA file. In addition, the trustee software tool may identify and add a standardized remittance advice attribute (e.g., a reason for the payment) to the data. Furthermore, in response to a processor detecting a submission via a user interface, the trustee software tool may generate a payment using the NACHA file and send the NACHA file to a financial institution of the creditor via an ACH network.

In this case, the trustee software tool may send the payment details (e.g., amount, financial institution ID, debtor ID, etc.) to the financial institution via a first NACHA file. In addition, the trustee software tool may create/trigger a second NACHA file associated with the same transaction and send the second NACHA file to the financial institution of the creditor. Here, the second NACHA file may include information about the remittance advice such as the reason for the payment, an identifier of bankruptcy claim, an identifier of the bankruptcy, etc., via the second NACHA file. The second NACHA file may be sent simultaneously with the first NACHA file or before or after the first NACHA file.

The National Data Center (NDC) was established in 2001 as an adjunct to the National Association of Chapter 13 Trustees. The NDC provides a comprehensive web-based central source for Chapter 13 case and claim data. The data can be furnished to parties-in-interest through a single state-of-the-art secured Internet web site while taking all necessary steps to protect the privacy interests of debtors. The NDC provides a cost-effective method to manage bankruptcy claims through the intelligent use of data. Data is consolidated from nearly 200 individual bankruptcy trustees into one comprehensive secure database. The information stored in the database is updated on a nightly basis.

The NDC provides various services such as tracking and management of debtor payments and trustee disbursements. The NDC enables improved productivity through the use of timely, accessible, and quality data. Furthermore, the NDC also provides options to automate payment and other account postings, as well as electronic exception determination to better analyze portfolios.

Subscribers to the NDC can analyze their entire bankruptcy case portfolio through a variety of access methods. The basic subscription package includes unlimited login privileges for a bankruptcy team to view detailed case information in which the user is a party-in-interest. The NDC website displays case receipt and disbursement information, relevant case date information, and claim data.

The NDC also provides an application programming interface (API) that enables data records of a bankruptcy to be queried. Here, individual claim records can be queried based on a claim ID. As another example, an entire bankruptcy proceeding record can be queried based on a bankruptcy ID, trustee ID, etc. Each response from the API includes a data set with dozens of different data values (e.g., 30-40 data values or more).

In the example embodiments, the trustee software tool may include a data store with a list of different standardized remittance advice reasons. The trustee software tool may interpret a data set returned from the NDC API and select a standardized remittance advice from among the different standardized remittance advice reasons based on the interpretation of the data set. To interpret the data returned from the NDC API, the example embodiments provide a matrix. Not all of the data values returned from the NDC API are helpful for identifying the standardized remittance advice. Here, the matrix can use only a subset of data values returned by the API rather than all of the values returned by the API for the bankruptcy claim, when determining the remittance advice reasoning. Which subset of data values are used may be the same for each type of claim or it may differ. Examples of the data values that are used by the matrix include, but are not limited to, trustee ID, trustee claim code, claim type, claim type description, class type, class description, and the like.

Through the API connection, the trustee software may pull data (non-structured) from the NDC. Here, the trustee software is getting data from almost 200 trustees, many of which are using different formats, etc. This data is “unstructured” because there is no standardized format for the data. Furthermore, there can be many different ways that the data is unstructured. For example, the descriptions of the payments submitted by the 200 trustees may have 200 different formats. Furthermore, through the API, the trustee software tool is able to pull thousands of bankruptcy records in just a short amount of time (e.g., 30 seconds, one minute, etc.) Thus, the querying via the API enables data to be pulled directly from the National Data Center in just a short amount of time (e.g., a few seconds to a minute, etc.) using API calls through the API.

In the example embodiments, the trustee tool can pull bankruptcy data via the API connection with the National Data Center, interpret it through a matrix that has been built to interpret the data so that it's streamlined into a dataset that can be added to an ACH transaction. Here, the trustee tool can identify the particular values necessary to fill out the fields of a NACHA file, such as shown and described with respect to the NACHA file 330 in FIG. 3A. Also, this process can work with a mortgage servicing system and its uniform. The matrix may include predefined rules, machine learning, statistics, and the like, which can identify the most likely candidate for a remittance advice reason either by direct matching or intelligent matching. For example, if the trustee tool can match all of the values in the subset of data values, the system can make a direct mapping. As another example, when not all of the values are a match for a predefined rule, the trustee tool can use intelligence (match 5, match 4, etc.) of individual rules for various values of trustee ID, trustee claim code, claim type code, claim type description, class description, a class type comments, and the like.

Once the trustee tool has the interpretation of the data and the standardized remittance advice, the trustee tool may store the structured data record within a file such as a spreadsheet that includes multiple structured data records for a given bankruptcy proceeding. Each loan may have one or more claims. The trustee tool may create a spreadsheet that has all the values pulled from the HTTP responses from the, and the interpretation fields. We also add some additional data. Then we send it to a client system which is a gateway to the network.

The trustee tool may have a client master list of loans with hundreds or even thousands of proceedings and claims. Here, the trustee tool may attempt to pull data from the NDC on a regular basis such as daily or weekly for each of these proceedings and/or claims.

The trustee tool may compare the newly pulled data to what is already stored in the master list to identify what the differences are from the day. If no differences exist, the trustee tool may leave the data record unchanged. However, if the data has changed, the trustee tool will update the data. A client may send their updated master list every day or week. The standardized remittance advice may be stored in a specific field of the ACH message (NACHA file). The trustee tool can prepare a ACH file consistent with NACHA rules required for submission via an ACH network. This remittance advice goes to the banks. The client is a bank. It's a bank that wants to receive its funds electronically along with the proprietary instructions on how to post it. From the bank's perspective, they are getting the funds, and they are getting the instructions which have been appended to the ACH NACHA file with remittance advice.

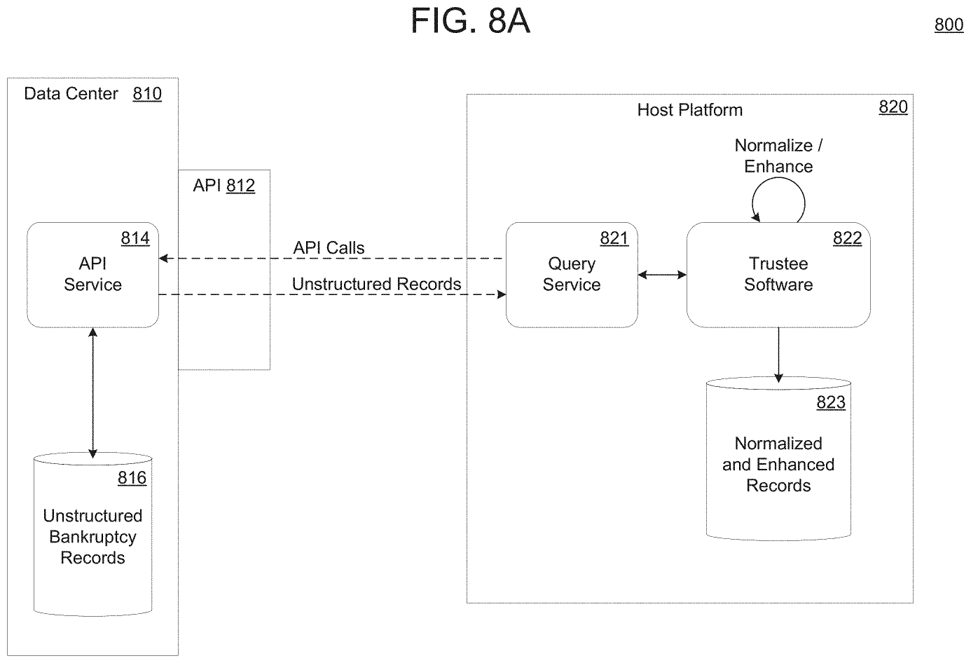

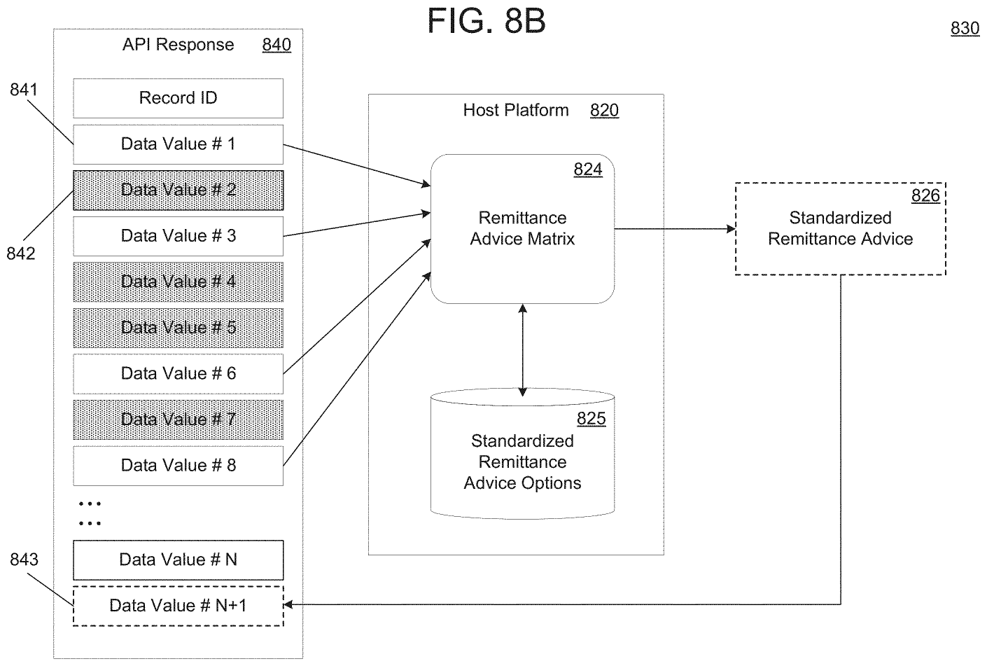

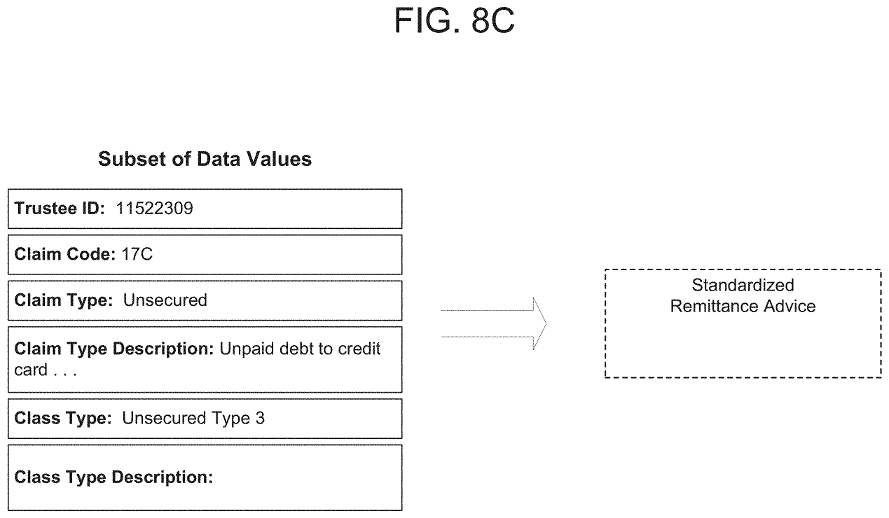

FIG. 8A illustrates a process 800 of pulling and transforming data from a data center 810, according to example embodiments. Referring to FIG. 8A, a host platform 820 such as a web server, a cloud platform, or the like, hosts a trustee software 822 which may be the same tool as the trustee software tool 120 shown and described in FIG. 1, but embodiments are not limited thereto. The trustee software 822 may pull data from an external data source such as a data center 810. For example, the trustee software 822 may submit requests (e.g., API calls, HTTP queries, etc.) via an API 812 of the data center 810. Results from the querying may be returned to the trustee software 822 via the API 812.

In this example, the host platform 820 may also host a query service 821 for querying the data center 810. As another example, the query service 821 may be built into the trustee software 820. In particular, the trustee software 822 may query the data center 810, via the query service 821, for data records of bankruptcies. Each bankruptcy proceeding may include one or more claims from one or more creditors. Each proceeding and each claim may be queried. The data that is returned may be unstructured data. Here, the data center 810 includes an API service 814, such as a web service, that retrieves the unstructured data records from an unstructured database 816 and returns the unstructured results to the query service 821. In response, the trustee software 822 may extract relevant data attributes from the normalized data and generate a structured data record that includes the extracted data attributes in predefined fields. Furthermore, the trustee software 822 may enhance the structured data with remittance advice data that can be added to the structured data record and recorded in a database 823 of the host platform 820.

FIG. 8B illustrates a process 830 of selecting a standardized remittance advice data 826 for a data record pulled via the API 814 of the data center 810 shown in FIG. 8A, according to example embodiments. Referring to FIG. 8B, an API response 840 from the API 814 of the data center 810 includes a set of data values where the set includes 1, 2, 3, . . . N data values. In this example, the trustee software may include a remittance advice matrix 824 capable of interpreting the set of data values 1, 2, 3, . . . N and selecting a standardized remittance advice data value 826 from a larger set of standardized remittance advice data values that are previously stored in a database 825.

Not all of the data values from the set are needed by the remittance advice matrix 824. For example, the remittance advice matrix 824 may extract a subset of data values (e.g., 6-7 data values) from among the larger set (e.g., 30-40 data values) and determine the standardized remittance advice data value 826 based exclusively on the subset of data values. In FIG. 8B, data values that are translucent (such as data value 841) represent data values that are used by the remittance advice matrix 824 when selecting the standardized remittance advice data value 826 while data values that are shaded (such as data value 842) represent data values that are not used by the remittance advice matrix 824.

FIG. 8C illustrates a process of transforming a claim record into an enhanced and transformed record according to example embodiments. In this example, a subset of data values are used by the remittance advice matrix to identify a standardized remittance advice.

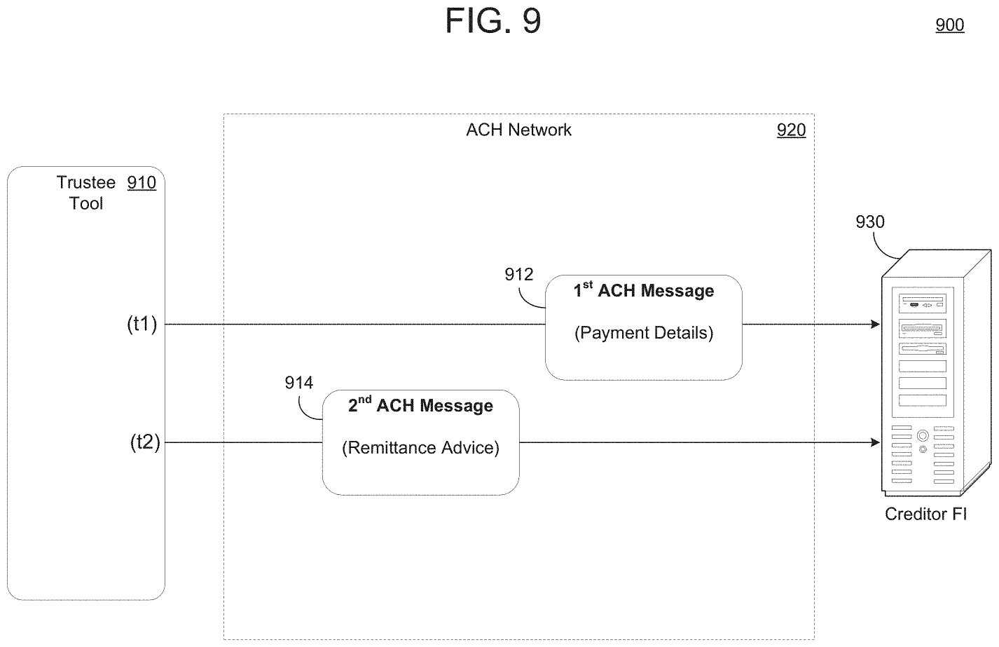

FIG. 9 illustrates a process 900 of submitting a payment and remittance advice to a creditor according to example embodiments. Referring to FIG. 9, a trustee software 910 may provide a user interface (not shown) which allows a user to interact with the data records and to submit payments. For example, a user may request a payment by pressing an input button in the user interface to have a payment made for any of the claims that are currently managed for the user in the trustee software. The input via the user interface may be detected by the trustee software (e.g., by a processor executing the trustee software, etc.) and may trigger a payment process. The payment process may be a single payment such as shown in the example of FIG. 9. However, the payment process may also be a batch payment in which multiple payments such as shown in FIG. 9 are performed simultaneously.

As shown in FIG. 9, in response to detecting a request for payment submission of a claim via a user interface, the trustee software 910 generates and sends a first ACH message 912 (or NACHA file) with payment details for a payment transaction from a trustee to a creditor. Here, the ACH message 912 is sent to a bank computer 930 of a financial institution that holds a payment account for the creditor. The payment details may include a payment amount, account identifiers, names, addresses, etc. necessary for processing the payment via an ACH network. In addition, the trustee software 910 may also send a second ACH message 914 with remittance advice data therein for the payment transaction that is submitted via the first ACH message 912. In some embodiments, the second ACH message 914 may include an identifier (e.g., message ID, etc.) of the first ACH message 912.

In some embodiments, the trustee software 910 may send the first ACH message 912 before sending the second ACH message 914. As another example, the first and second ACH messages 912 and 914 may be sent at the same time.

In response to receiving the first ACH message 912, the creditor's financial institution may process the payment. Furthermore, upon receiving the second ACH message 914, the financial institution can provide the remittance advice data values to the creditor via a user interface, email, account web page, etc.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to
query a web server for a record of a bankruptcy claim of a creditor via an application programming interface (API) of the web server and receive a set of data values for the record of the bankruptcy claim that are returned from the web server in response to the query,
identify a standardized remittance advice for the bankruptcy claim from among a plurality of predetermined standardized remittance advices, based on a subset of values from the set of data values,
detect, via an input on a user interface, a request to send a payment for the bankruptcy claim to the creditor,
generate a first National Automated Clearing House Association (NACHA) file for the bankruptcy claim that includes payment information for the bankruptcy claim, and
generate a second NACHA file for the bankruptcy claim that includes the identified standardized remittance advice for the bankruptcy claim; and
a network interface configured to transmit the first and second NACHA files for the bankruptcy claim to a financial institution of the creditor via an Automated Clearing House (ACH) network.

2. The computing system of claim 1, wherein the processor controls the network interface to transmit the first NACHA file prior to transmitting the second NACHA file.

3. The computing system of claim 2, wherein the processor is further configured to insert an identifier of the first NACHA file into a field of the second NACHA file prior to transmitting the second NACHA file.

4. The computing system of claim 1, wherein the processor is configured to identify a standardized description for the payment information of the bankruptcy claim selected from among a plurality of standardized descriptions for a plurality of different types of payments which are stored in memory, respectively.

5. The computing system of claim 1, wherein the processor is configured to receive an unstructured description of the bankruptcy claim from the web server, and normalize the unstructured description into a predefined structure that includes a plurality of predefined fields and values within the plurality of predefined fields extracted from the unstructured description.

6. The computing system of claim 1, wherein the processor is configured to identify the standardized remittance advice based on a matrix that extracts the subset of values, interprets the subset of values, and determines the standardized remittance advice based on the interpretation.

7. The computing system of claim 1, wherein the subset of values comprise values selected from three or more of a trustee ID field, a trustee claim code field, a claim type code field, a claim type description field, a class description field, and a class type field, which are included in the set of values returned by the API.

8. A method comprising:
querying, via a processor, a web server for a record of a bankruptcy claim of a creditor via an application programming interface (API) of the web server and receiving a set of data values for the record of the bankruptcy claim that are returned from the web server in response to the querying;
identifying, via the processor, standardized remittance advice for the bankruptcy claim from among a plurality of predetermined standardized remittance advices, based on a subset of values from the set of data values;
detecting, via an input on a user interface, a request to send a payment for the bankruptcy claim to the creditor;
generating a first National Automated Clearing House Association (NACHA) file for the bankruptcy claim that includes payment information for the bankruptcy claim;
generating a second NACHA file for the bankruptcy claim that includes the identified standardized remittance advice for the bankruptcy claim; and
transmitting the first and second NACHA files for the bankruptcy claim to a financial institution of the creditor via an Automated Clearing House (ACH) network.

9. The method of claim 8, wherein the transmitting comprises transmitting the first NACHA file prior to transmitting the second NACHA file.

10. The method of claim 9, wherein the method further comprises inserting an identifier of the first NACHA file into a field of the second NACHA file prior to transmitting the second NACHA file.

11. The method of claim 8, wherein the identifying comprises identifying a standardized description for the payment information of the bankruptcy claim selected from among a plurality of standardized descriptions for a plurality of different types of payments which are stored in memory, respectively.

12. The method of claim 8, wherein the querying comprises receiving an unstructured description of the bankruptcy claim from the web server, and normalizing the unstructured description into a predefined structure that includes a plurality of predefined fields and values within the plurality of predefined fields extracted from the unstructured description.

13. The method of claim 8, wherein the identifying comprises identifying the standardized remittance advice based on a matrix that extracts the subset of values, interprets the subset of values, and determines the standardized remittance advice based on the interpretation.

14. The method of claim 8, wherein the subset of values comprise values selected from three or more of a trustee ID field, a trustee claim code field, a claim type code field, a claim type description field, a class description field, and a class type field, which are included in the set of values returned by the API.

15. A non-transitory computer readable medium comprising program instructions which when executed cause a computer to perform a method comprising:
querying, via a processor, a web server for a record of a bankruptcy claim of a creditor via an application programming interface (API) of the web server and receiving a set of data values for the record of the bankruptcy claim that are returned from the web server in response to the querying;
identifying, via the processor, standardized remittance advice for the bankruptcy claim from among a plurality of predetermined standardized remittance advices, based on a subset of values from the set of data values;
detecting, via an input on a user interface, a request to send a payment for the bankruptcy claim to the creditor;
generating a first National Automated Clearing House Association (NACHA) file for the bankruptcy claim that includes payment information for the bankruptcy claim;
generating a second NACHA file for the bankruptcy claim that includes the identified standardized remittance advice for the bankruptcy claim; and
transmitting the first and second NACHA files for the bankruptcy claim to a financial institution of the creditor via an Automated Clearing House (ACH) network.

16. The non-transitory computer-readable medium of claim 15, wherein the transmitting comprises transmitting the first NACHA file prior to transmitting the second NACHA file, and the method further comprises inserting an identifier of the first NACHA file into a field of the second NACHA file prior to transmitting the second NACHA file.

17. The non-transitory computer-readable medium of claim 15, wherein the identifying comprises identifying a standardized description for the payment information of the bankruptcy claim selected from among a plurality of standardized descriptions for a plurality of different types of payments which are stored in memory, respectively.

18. The non-transitory computer-readable medium of claim 15, wherein the querying comprises receiving an unstructured description of the bankruptcy claim from the web server, and normalizing the unstructured description into a predefined structure that includes a plurality of predefined fields and values within the plurality of predefined fields extracted from the unstructured description.

19. The non-transitory computer-readable medium of claim 15, wherein the identifying comprises identifying the standardized remittance advice based on a matrix that extracts the subset of values, interprets the subset of values, and determines the standardized remittance advice based on the interpretation.

20. The non-transitory computer-readable medium of claim 15, wherein the subset of values comprise values selected from three or more of a trustee ID field, a trustee claim code field, a claim type code field, a claim type description field, a class description field, and a class type field, which are included in the set of values returned by the API.
